(19) United States
(12) Patent Application Publication
(10) Pub. No.: US 2016/0055716 A1
(43) Pub. Date: Feb. 25, 2016

(54) POWER PLAY ROULETTE

(71) Applicant: AGS, LLC, Las Vegas, NV (US)

(72) Inventor: Magdalena Young-Czyzewski, Henderson, NV (US)

(21) Appl. No.: 14/699,864

(22) Filed: Apr. 29, 2015

Related U.S. Application Data
(60) Provisional application No. 62/038,891, filed on Aug. 19, 2014.

(51) Int. Cl. G07F 17/32

(52) U.S. Cl. CPC G07F 17/3244; G07F 17/3211

(57) ABSTRACT

A modified wagering method for a traditional roulette game called Power Pay Roulette provides a wider range of game winnings as compared to the standard roulette game. A method of wagering on a Power Pay Roulette includes additional wagering options for a single event which provides multiple random payouts in place of a single payout in the standard roulette game. A game system for implementing Power Pay Roulette may include a display, a user interface and a processor. The processor executes instructions that cause the processor to recognize roulette wheel events, display winning numbers and winning payouts.

### CROSS REFERENCE TO RELATED APPLICATION

This application claims priority to U.S. Provisional Application No. 62/038,891 which was filed on Aug. 19, 2014, the contents of which are incorporated herein by reference.

### BACKGROUND

Roulette is a very popular casino game. There are a few differences between how the game is played in the US and Europe, but it is a very traditional game and its modifications have been minimal over the course of many decades.

Many casinos in the world play roulette in a very traditional style with a very few modifications or side bets. Side bets are very popular for most table games. Roulette on the other hand, because of the way it is played, does not present a good environment for a side bet or modification which would attract additional players. The exception to this might be the two-wheel roulette arrangement, which is somewhat popular in European casinos.

Table games, in general, benefit from additional side bets or modified wagering for the base game by providing additional wagering options and additional game strategies, thus enhancing the game experience and possibly increasing casino revenue.

It is believed there is a need for a roulette game which would provide a wider range of winnings while not significantly changing the game environment. Such an enhancement would attract additional players to the game while simultaneously retaining existing players by not changing the game environment. Such additional or modified wagering on roulette is also thought to provide additional revenue to casinos.

### SUMMARY

The disclosed embodiments have been developed in light of the above, and aspects of the invention may include a wagering game, gaming devices and systems, and methods for presenting and playing a wagering game. According to some embodiments, a casino wagering game may be referred to as “Power Pay Roulette.” In one embodiment Power Pay Roulette may be a modified wagering method for a traditional roulette game as described herein.

Embodiments of Power Pay Roulette are directed to systems and methods for operating a roulette game with a wider range of game winnings as compared to a traditional roulette game.

A method of wagering in Power Pay Roulette includes additional wagering options for a single event which provides multiple random or varied payouts in place of a single fixed payout in the standard roulette game.

The additional wagering options may provide an identical betting method as in traditional roulette. Players may bet on a specific number or a group. In traditional roulette, the payout for a single number win is generally 36:1. In Power Pay Roulette, the payout may be randomly chosen from a set of fixed payouts. In one embodiment, an average payout, however, remains 36:1 or lower.

In Power Pay Roulette, payouts may be randomly selected with predetermined probabilities. In one embodiment, a first payout may be greater than the traditional payout but have a low probability of occurring. A second payout may be lower than the traditional payout but have a high probability of occurring. According to one explanatory example, there may be a first payout of 144:1 (e.g. 144 times the wager $, such as $144 for a $1 wager) that has a probability of 1/10 and a second payout of 24:1 that has a probability of 9/10. In this example, if a player selects a winning number, he or she can win a payout or winnings of either 24:1 or 144:1 depending on which payout is selected.

The range of possible winnings may thus be wide and the highest win may be large enough to encourage players to bet in Power Pay Roulette. Payout possibilities may be modified to allow for a wide variety of outcomes. For example, payouts with probabilities of 1/3 to 1/1,000,000 may be utilized with corresponding payout amounts such that an average payout remains 36:1 or lower for a single number win. Payouts for group of numbers and other traditional roulette groups can be similarly modified to be incorporated in Power Pay Roulette.

In some embodiments, an apparatus for playing Power Pay Roulette is provided that includes a minimal set of items above that which is required for a traditional roulette table game. These items may include a display, an interface to a roulette wheel, a memory, and a processor. The processor is configured to execute instructions stored on the memory that cause the processor to recognize roulette wheel events, to display a generated single number payout for the current spin, to receive an input from the wheel interface, and to generate or receive a random event for payout generation.

Accordingly, the disclosed embodiments enhance a traditional roulette game with a set of gaming systems, apparatuses, and methods.

Further objects, features, and advantages of the present invention over the prior art will become apparent from the detailed description of the embodiments which follows, when considered with the attached figures.

### BRIEF DESCRIPTION OF THE DRAWINGS

The accompanying drawings, which are incorporated herein and constitute part of this specification, include one or more embodiments of the invention, and together with a general description given above and a detailed description given below, serve to disclose principles of the disclosed embodiments.

FIG. 1 illustrates an embodiment of a power pay game method.

FIG. 2 illustrates an embodiment of an exemplary chip sleeve.

FIG. 3 illustrates an embodiment of a video screen of an exemplary display presenting the payout multiplier for the single number bet for the current winning number.

FIG. 4 illustrates an embodiment of a system implementation of Power Pay Roulette.

### DETAILED DESCRIPTION OF EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Reference will now be made to embodiments of apparatus, systems and methods for wagering in a roulette game referred to herein as Power Pay Roulette, examples of which are illustrated in the accompanying drawings. Details, features, and advantages of Power Pay Roulette will become further apparent in the following detailed description of embodiments thereof.

Systems, apparatuses, and methods to perform Power Pay Roulette are described herein. Any reference in the specification to “one embodiment,” “a certain embodiment,” or any other reference to an embodiment is intended to indicate that a particular feature, structure or characteristic described in connection with the embodiment is included in at least one embodiment and may or may not be utilized in other embodiments as well.

Power Pay Roulette can be played in various environments. In a brick-and-mortar casino it may be added to or implemented at a standard roulette table. It may also be added to any variation of electronic table roulette or roulette gaming machine where a roulette wheel is controlled electronically. Power Pay Roulette can be played in a virtual environment as well, where a roulette wheel is simulated by a computer (such as at stand-alone or linked gaming machines or other gaming devices, such as in mobile or Internet environments). In any of these environments the winning number is always a result of a random event, in which the number is selected from a set of possible outcomes.

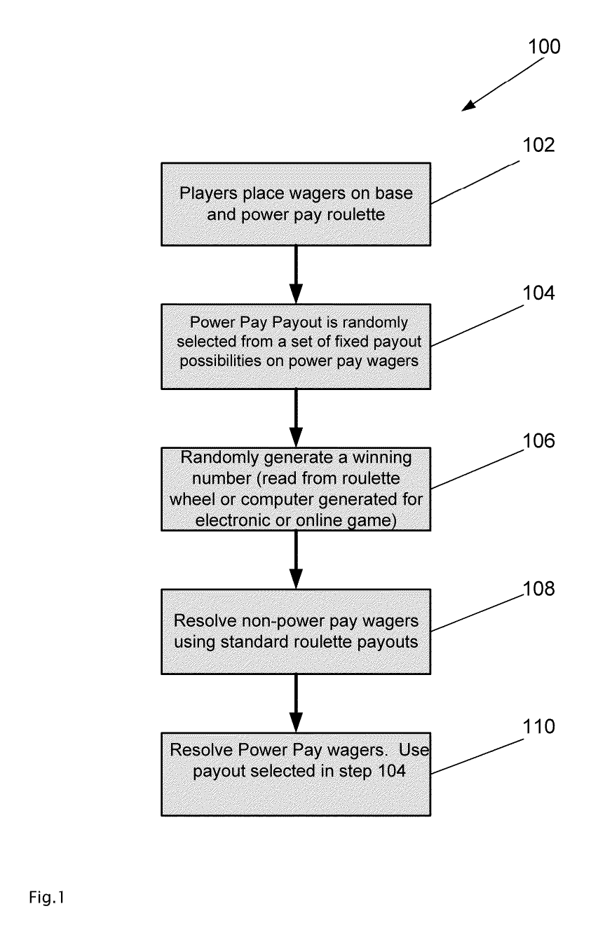

FIG. 1 illustrates an embodiment of a roulette game method 100. Specifically, FIG. 1 shows a flowchart for a roulette game with a “power pay” betting option.

Initially, in step 102, one or more players may have an opportunity to place wagers for a standard roulette game and/or Power Pay Roulette. The standard roulette game and Power Pay Roulette may be played simultaneously, or only wagers for the Power Pay Roulette game may be placed.

In step 104, a power pay payout is selected. Preferably, the power pay payout is randomly selected from a set of fixed payout possibilities for the single-number win and/or any other standard roulette bet options for which a power pay betting option is defined. The payout selection is performed electronically either at the roulette table or in the back-of-house and sent to a table, or by a computer interface for any virtual environment. The payout may be generated by a random selection from a set of predefined payouts. For example, an RNG may be used to select one of the power pay payout possibilities.

In one embodiment, the statistical average value generated payouts should be equal to or less than the corresponding payout for a standard roulette win. For example, a traditional roulette payout for a single number win is 36:1. Thus, according to the Power Play Roulette, there may be one or more payout possibilities that pay lower than 36:1, and one or more payout possibilities that pay higher than 36:1. However, based on the probabilities of how often the payout possibilities occur, an average payout for the single number win may remain 36:1 or lower. Of course, the embodiments are not limited to the average payout being 36:1 or lower. The average payout may be adjusted to the preferences of a game operator taking into account any number of factors such as a desired house edge in the game.

According to one example, there may be a first payout rate of 144:1 that has a probability of occurrence of 1/10 and a second payout rate of 24:1 that has a probability of occurrence of 9/10. In this example, if a player selects a winning number, he or she can win a payout of either 24:1 or 144:1 (e.g. 24 times or 144 times their wager) depending on which payout rate is selected. The statistical expected payout value for this set of payouts is 36:1, which is typical of traditional roulette payout in many casinos.

In another example, the first payout rate may be 100:1 and have a probability of occurrence of 1/8, and second payout rate may be 24:1 and have a probability of occurrence of 7/8. In this example, the statistical expected payout value is less than 36:1. While the payout pay be represented as a ratio or spread, such as 24:1 or 100:1, it could be represented in other fashions, such as by a multiplier value. For example, the base payout might comprise a value of X and the higher payout value might be a multiplier thereof, such as 2×, 4×, 5× or the like. For example, if the base payout is 24:1 and the higher payout is 144:1, the base payout might be designated as X and the higher payout as 6×. In other embodiments, the payouts might be represented in reference to the standard payout. For example, if the standard payout is 36:1, then a base payout of 18:1 might be designed as ½× and a higher payout of 72:1 might be designated as 2×.

Of course, any number and variation of winning outcomes with different probabilities may be utilized, with the above only meant to be exemplary. For instance, while the above examples include two payout possibilities in each set, there may be more than two payout possibilities in a set. Further, while in these examples a first payout higher than the traditional payout and a second payout lower than the traditional payout have been selected, other variations could be utilized (such as 2 payouts greater than the traditional payout and 3 payouts less than the traditional payout, etc.) The probabilities for outcomes having a payout greater than a traditional game payout may vary, such as ranging from 1/3 to 1/1,000,000. The corresponding payouts for such probabilities may be adjusted accordingly.

In step 106, an actual selection of the winning outcome is determined or performed. For a single number wager this may comprise selecting or determining the winning number. The selection event can be performed in a physical or virtual environment using a physical roulette wheel or a computer simulation. In both cases, the selection is a random process. In one embodiment, steps 104 and 106 may be performed simultaneously. That is, the random payout possibility for the Power Pay Roulette may be selected while the roulette wheel spins to select the winning outcome (such as winning number and winning color).

In steps 108 and 110, the various wagers are resolved for the standard roulette wagers (if permitted) and the power pay wagers, respectively. Payouts are paid to players who wagered on the winning numbers selected in step 106. Players who wagered using the power pay option receive payouts selected in step 104. Payouts may be made in the form of chips, credits, money, etc.

In one embodiment, Power Pay Roulette is an optional wager that is made during or as part of a traditional roulette game. In a virtual environment or using chipless wagering, the ability to place a power pay wager may be implemented by modifying control instructions of a gaming machine or electronic gaming table and adding necessary items to display on the betting screen. At a traditional, physical roulette table, adding an additional power pay wager to the table layout may be achieved in at least one of the following two manners.

In one embodiment, there may be separate betting areas for standard roulette wagering and Power Pay Roulette wagering. This may be accomplished by splitting the betting areas or by adding an additional separate roulette wagering area for the power pay wagering.

In another embodiment, the power pay wagers may be placed in the same betting areas as the traditional roulette wagers. In this embodiment, different chips, for example, may be used for the power pay betting. This could be accomplished by marking some regular chips with some distinct symbol to mark the chips to be used for power pay betting or to use a simple and small chip sleeve to be used for chips wagered on Power Pay Roulette. Such sleeves could be available to players in a few places around the table. The same chip sleeves could be used by all players at the table.

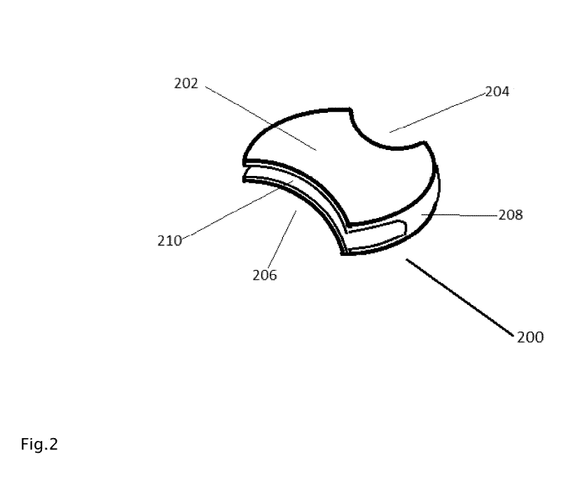

FIG. 2 depicts an embodiment of a chip sleeve 200. The sleeve's top 202 and bottom are circular disks with cutouts 204 and 206 to allow a chip to be easily inserted and removed. A side 208 of the sleeve extends along a small portion of a circumference of the sleeve 200 to allow facilitate the insertion and removal of a chip. In this way, the chip may only be inserted and removed through a sleeve opening 210 defined by the cutout 206, and may not be removed from the cutout 204. The illustrated sleeve 200 is just one embodiment of a holder, marker or the like for a chip (such as by covering, holding, or marking all or part of a chip).

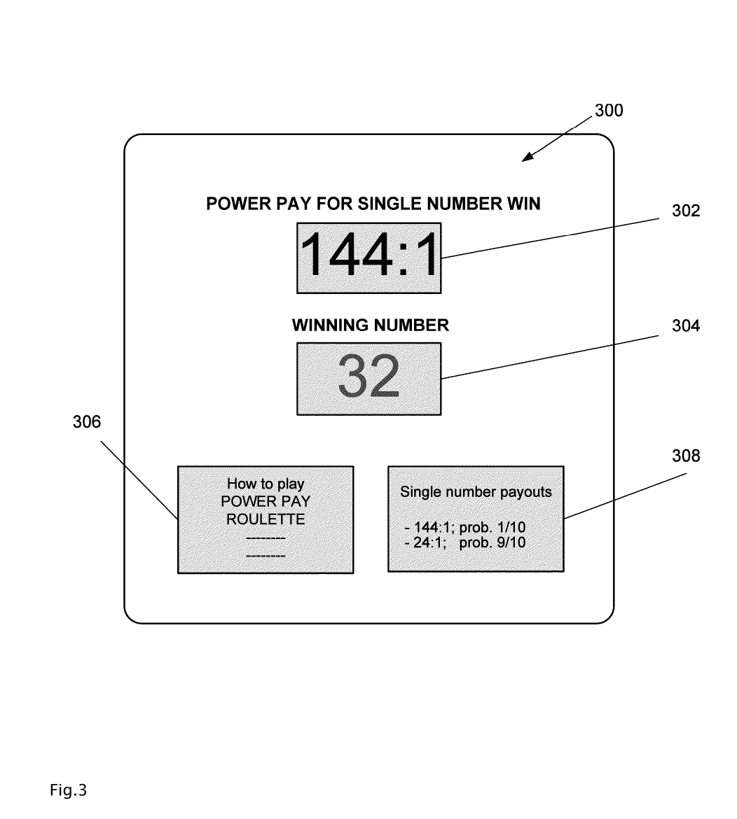

A roulette table which offers Power Pay Roulette may be equipped with one or more displays, such as electronic video displays, to present the selected payout for the current round (generated in step 104). FIG. 3 illustrates an example Power Pay Roulette screen 300, (e.g., graphical information presented on one or more displays). In one embodiment, the screen may display payout selected for the single number bet 302 for the current roulette spin. The screen may also present the winning number 304. The screen may also display relevant information for any typical roulette wager for which a Power Pay Roulette option is available. In some embodiments, the display may depict all payout possibilities 308 for the single number bet. The display may further display the occurrence frequencies (or probabilities) for each of the payout possibilities 308. It may also display power pay possibilities for other wagers such as for number-group wins or colors. The screen can provide additional information 306 about betting instructions on Power Pay Roulette.

It is further noted that the screen 300 may take on any other number of formats. For example, the payout for the single number bet 302 may be displayed as a base payout amount or a multiplier amount. For example, display 302 may be blank or display that the payout is a base payout when the single number wager will be paid at 24:1. However, if the payout is selected to be 144:1, the display 302 may display that the payout for this round has a 6× multiplier. Furthermore, lights, sounds, animations, or the like may be incorporated into the screen 300 when the payout that is higher than the traditional roulette game payout is awarded for a winning number, group, or color.

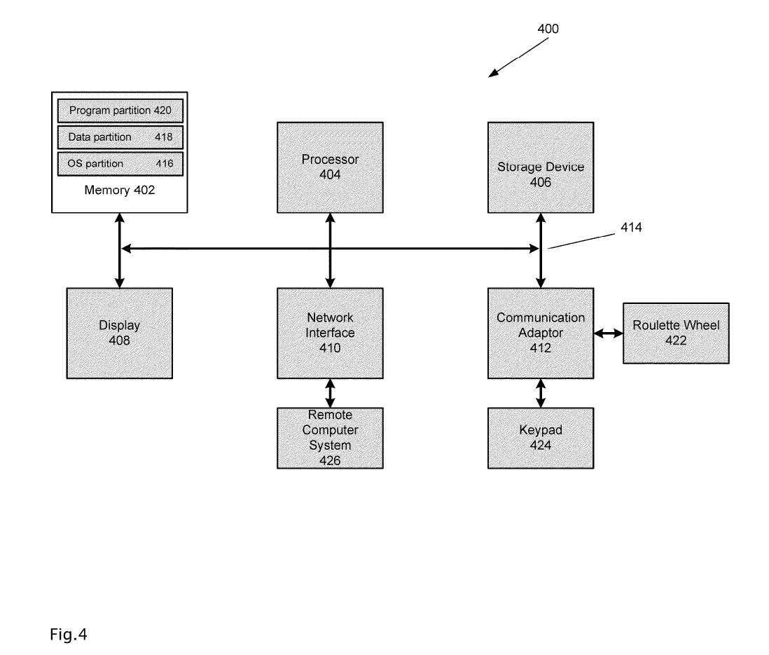

The Power Pay Roulette display maybe communicatively connected to a computer system which runs the required software and interacts with peripheral devices. FIG. 4 illustrates an embodiment of the Power Pay Roulette computer system 400 for a physical roulette table, which may include a memory 402, a processor 404, a table display 408, a network interface 410, a storage device 406, and one or more communication adaptors 412. The Power Pay Roulette computer system 400 may furthermore be coupled to a remote computer system 426 through network interface 410.

Communication between the memory 402, the processor 404, the storage device 406, the display 408, the network interface 410, and the communication adaptor 412 may be performed by way of one or more communication busses 414. Those busses 414 may include, for example, a system bus, a peripheral component interface bus, and an industry standard architecture bus.

The memory 402 may include any memory device including, for example, random access memory (RAM), dynamic RAM, and/or read only memory (ROM) (e.g., programmable ROM, erasable programmable ROM, or electronically erasable programmable ROM) and may store computer program instructions and information. The memory may furthermore be partitioned into sections including an operating system partition 416 in which operating system instructions are stored, a data partition 418 in which data is stored, and a program partition 420 in which instructions for carrying out the system services are stored. The program partition 420 may store program instructions, such as for Power Pay Roulette, and allow execution by the processor 404 of the program instructions. The data partition 418 may furthermore store data such as one or more operating parameters to be used during the execution of the program instructions.

The communication adaptor 412 permits communication between the Power Pay Roulette system 400 and other devices or nodes coupled to the communication adaptor 412 such as keypad 424 and roulette wheel interface 422. The keypad 424 (and/or one or more other input devices) allows a dealer to trigger system events or data input if required. The wheel interface 422 provides winning number data and triggers the generation of a win multiplier for every spin. The win multiplier can be generated by Power Pay Roulette services 420 or by remote computer system 426.

It should be recognized that any or all of the components 402-424 may be implemented in a single machine. For example, the memory 402 and processor 404 might be combined in a state machine or other hardware based logic machine.

The Power Pay Roulette computer system 400 may be implemented along with real-chip wagering supervised by a dealer or with electronic chip-less wagering, or on a network. A network in which a Power Pay Roulette game may be implemented may be a network of nodes, which are typically processor-based devices, interconnected by one or more forms of communication media. The communication media coupling the Power Pay Roulette computer system 400 to one or more other devices or a network may include, for example, co-axial cable, optical fibers, and wireless communication methods such as use of radio frequencies.

FIG. 4 illustrates just one embodiment of a system. For example, the system 400 might include one or more detectors, such as for detecting the outcome of a roulette wheel spin (e.g. ball detectors, cameras or the like). In other embodiments, a croupier may utilize an input device to indicate the outcome of a spin of the roulette wheel.

As further indicated herein, the system might be applied to automated roulette wheels, such as wheels which are automatically spun (rather than by hand), etc.

The invention may be applied to gaming devices, such as gaming machines which are capable of presenting roulette games, such as simulated roulette games (such as where the outcome of the roulette spin is computer generated/selected and the roulette wheel spin might be represented graphically, such as on a video display). The gaming machines might be stand alone, linked with other machines, and or be associated with one or more game servers (such that the gaming machines themselves are thin clients which essentially just present the game outcomes). In such environments, a single player might play the roulette game of the invention as a gaming device. Further, while such devices might comprise traditional casino-style machines having a housing, processor, wager input device(s), player input device(s), one or more video displays and the like, such devices might comprise computers (including laptops, tablets, desk tops and the like), and even mobile computers or communication devices, such as PDAs and the like.

In one embodiment, an existing or standard roulette game (such as which offers standard or traditional wagers and associated payouts) is modified to include the power pay feature described herein. In other embodiments, it is possible for the roulette game to only offer the power pay wagering feature or the power pay wagering feature and some of the traditional roulette wagers but not all of them. For example, a game of the invention might offer only the power pay wager on single numbers, but still offer other of the traditional roulette wagers.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A roulette wagering system, comprising:
a roulette wheel;
at least one electronic video display;
a non-transitory, computer-readable medium; and
a processor coupled to the roulette wheel, the at least one display, and the computer-readable medium; the processor executing instructions stored on the computer-readable medium which cause the processor to:
recognize a roulette wheel spin event and at least one spin outcome on the roulette wheel;
select a payout from a set of predefined payouts, the set of predefined payouts including at least two payouts; and
display winning outcome information and information regarding the selected payout via said at least one electronic video display.

2. The system of claim 1, wherein the set of predefined payouts includes a first payout that is less than a typical roulette payout and a second payout that is greater than the typical roulette payout.

3. The system of claim 2, wherein the typical roulette payout is 36:1.

4. The system of claim 2, wherein the first payout has a probability of being selected greater than 1/2 as a result of said selecting step.

5. The system of claim 2, wherein the second payout has a probability of being selected less than 1/2 as a result of said selecting step.

6. The system of claim 1, wherein the set of predefined payouts are stored on a remote computer system and the step of selecting comprises receiving a selected payout from the remote computer system.

7. The system of claim 1, wherein the processor executing instructions stored on the computer-readable medium further causes the processor to:
receive a wager from a player for a traditional roulette game and an optional wager for the Power Pay Roulette game prior to the roulette wheel spin event via the user interface;
resolve the wager for the traditional roulette game according to a traditional payout; and
resolve the wager for the optional Power Pay Roulette game according to the selected payout from the set of predefined payouts.

8. The system of claim 7, further comprising gaming chips, wherein wagers are received via the gaming chips, and the gaming chips that are designated for the wager for the traditional roulette game are separated from the gaming chips that are designated for the wager for the Power Pay Roulette game.

9. The system of claim 8, further comprising a cover that receives at least a portion of the gaming chips that are designated for the wager for the Power Pay Roulette game.

10. They system of claim 1, wherein the processor executing instructions stored on the computer-readable medium further causes the processor to:
receive a wager from a player prior to the roulette wheel spin even via the user interface; and
resolve the wager according to the selected payout from the set of predefined payouts.

11. A roulette wagering system, comprising:
a roulette wheel;
at least one electronic video display;
a non-transitory, computer-readable medium; and
a processor configured to:
receive input regarding an outcome of a spin of said roulette wheel;
select a payout from a set of predefined payouts corresponding to a winning roulette game wager, the set of predefined payouts including at least a first payout and a second payout, said first payout being lower than a standard payout and said second payout being higher than a standard payout;
cause said at least one electronic video display to display information regarding said outcome of said spin of said roulette wheel and information regarding the selected payout.

12. The system of claim 11 wherein said first payout has a higher probability of being selected than said second payout.

13. The system of claim 11 wherein said winning roulette game wager comprises a single number wager.

14. The system of claim 11 wherein said standard payout is 36:1.

15. The system of claim 11 wherein said step of selecting a payout comprises looking up a payout from a lookup table.
